(19) United States
(12) Patent Application Publication
(10) Pub. No.: US 2019/0163154 A1
(43) Pub. Date: May 30, 2019

(54) DEVICE RECOMMENDATION SYSTEM AND METHOD

(71) Applicant: INSTITUTE FOR INFORMATION INDUSTRY, Taipei (TW)

(72) Inventors: Chih-Hsuan LIANG, New Taipei City (TW); Shih-Yu LU, Nantou County (TW); Chien-Kai HUANG, Taichung City (TW); Hsin-Tse LU, Taipei City (TW)

(21) Appl. No.: 15/834,031

(22) Filed: Dec. 6, 2017

(30) Foreign Application Priority Data
Nov. 29, 2017 (TW) 106141677

(51) Int. Cl. G05B 19/048

(52) U.S. Cl. CPC G05B 19/048; G06F 7/523; G05B 2219/24015; G05B 2219/2642

(57) ABSTRACT

A device recommendation system includes an environmental monitoring module, a device monitoring module, an abnormality monitoring module and a decision module. The environmental monitoring module receives environmental data obtained by environmental sensors and generates environmental history data accordingly. The device monitoring module retrieves enablement counts from electronic devices and generates enablement history data accordingly. The abnormality monitoring module determines whether the environmental data exceeds a threshold in a first time section and generates an abnormal signal accordingly. According to the abnormal signal, the decision module calculates the environmental history data based on an initial weight matrix to generate a recommendation data used to change the enablement status of the electronic devices. If the decision module no longer receives the abnormal signal in a second time section, the decision module adjusts the initial weight matrix according to the recommendation data to generate an adjusted weight matrix.

### CROSS-REFERENCE TO RELATED APPLICATION

This application claims priority to Taiwan Application Serial Number 106141677, filed Nov. 29, 2017, which is herein incorporated by reference.

### BACKGROUND

Nowadays, control systems that control the status of electronic devices simultaneously over a network are very common. However, the previous control system often overlooked that the on/off status between the electronic devices may have an interactive influence on the environmental data. In addition, the relationship between such electronic devices is also difficult to judge directly. For example, if the air conditioner is adjusted, the value of the humidity fed back by the dehumidifier may also change, and turning on the two electronic devices at the same time may also result in unnecessary energy consumption.

In addition, the on-state of the electronic device and the environmental data required by the user may also be different in different cyclic time sections each day depending on the user's needs. Therefore, the control system should consider a variation of environmental data in each cyclic time section to perform electronic devices adjustment. For example, users' tolerable volume in evening and late-night sessions should be different.

Therefore, the existing electronic device control system still has the above deficiencies and needs to be improved urgently.

### SUMMARY

An aspect of the present disclosure is directed to a device recommendation system. The device recommendation system comprises an interface and a processor. The interface receives a plurality of environmental data in a plurality of cyclic time sections obtained by a plurality of environmental sensors. The processor is electrically coupled to the interface and is communicatively coupled to a plurality of electronic device, in which the processor comprises an environmental monitoring module, a device monitoring module, an abnormality monitor module and a decision module. The environmental monitoring module generates environmental history data according to the environmental data in the cyclic time sections obtained by the environmental sensors. The device monitoring module generates device history data according to a plurality of enablement counts in the cyclic time sections of a plurality of electronic devices. The abnormality monitor module determines whether the environmental data exceeds an abnormal interval in the environmental history data in a first time section in the cyclic time sections, and generates an abnormal signal when one of the environmental data exceeds the abnormal interval. The decision module calculates the environmental history data via an initial weight matrix to generate first recommendation data configured to determine whether to enable the electronic devices when the decision module receives the abnormal signal. The initial weight matrix comprises a plurality of initial weights corresponding to the electronic devices. If the decision module does not receive the abnormal signal in a second time section in the cyclic time section, the decision module adjusts the initial weights in the initial weight matrix according to a variation of the environmental data and the first recommendation data to generate an adjusted weight matrix. The decision module calculates the device history data to generate second recommendation data configured to determine whether to enable the electronic devices according to the adjusted weight matrix when the decision module receives the abnormal signal in a third time section in the cyclic time sections.

Another aspect of the present disclosure is directed to a device recommendation method. The device recommendation method is performed by a processor, in which the processor is electrically coupled to a plurality of environmental sensors via an interface and is communicatively coupled to a plurality of electronic devices. The processor comprises an environmental monitoring module, a device monitoring module, an abnormality monitor module and a decision module. The recommendation method comprises the environmental monitoring module generating environmental history data according to the environmental data in the cyclic time sections obtained by the environmental sensors; the device monitoring module generating device history data according to a plurality of enablement counts in the cyclic time sections of a plurality of electronic devices; the abnormality monitor module determining whether the environmental data exceeds an abnormal interval in the environmental history data in a first time section in the cyclic time sections, and generating an abnormal signal when one of the environmental data exceeds the abnormal interval; the decision module calculating the environmental history data via an initial weight matrix to generate first recommendation data configured to determine whether to enable the electronic devices when the decision module receives the abnormal signal, in which the initial weight matrix comprises a plurality of initial weights corresponding to the electronic devices; if the decision module does not receive the abnormal signal in a second time section in the cyclic time sections, the decision module adjusting the initial weights in the initial weight matrix according to a variation of the environmental data and the first recommendation data to generate an adjusted weight matrix; and the decision module calculating the device history data to generate second recommendation data configured to determine whether to enable the electronic devices according to the adjusted weight matrix when the decision module receives the abnormal signal in a third time section in the cyclic time sections.

Therefore, according to the present disclosure, the embodiments of the present disclosure provide the device recommendation system and a device control method to improve the prior art which did not consider that multiple electronic devices may simultaneously have an influence on a plurality of environmental data, resulting in poor control efficiency. The device recommendation system and the device recommendation method can effectively recommend the electronic devices to be enabled or disabled according to the variation of the environmental data to improve the control efficiency of the electronic devices.

### BRIEF DESCRIPTION OF THE DRAWINGS

This disclosure can be more fully understood by reading the following detailed description of the embodiment, with reference made to the accompanying drawings as follows:

FIG. 1 is a schematic diagram of a device recommendation system in accordance with some embodiments of the present disclosure.

FIG. 2 is a schematic diagram of a device recommendation method in accordance with some embodiments of the present disclosure.

FIG. 3 is a schematic diagram of environmental history data in accordance with some embodiments of the present disclosure.

FIG. 4 is a schematic diagram of a smoothing process in accordance with some embodiments of the present disclosure.

FIG. 5 is a schematic diagram of an abnormal detection matrix in accordance with some embodiments of the present disclosure.

FIG. 6 is a schematic diagram of a device recommendation method in accordance with some embodiments of the present disclosure.

FIG. 7 is a schematic diagram of an initial weight matrix in accordance with some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

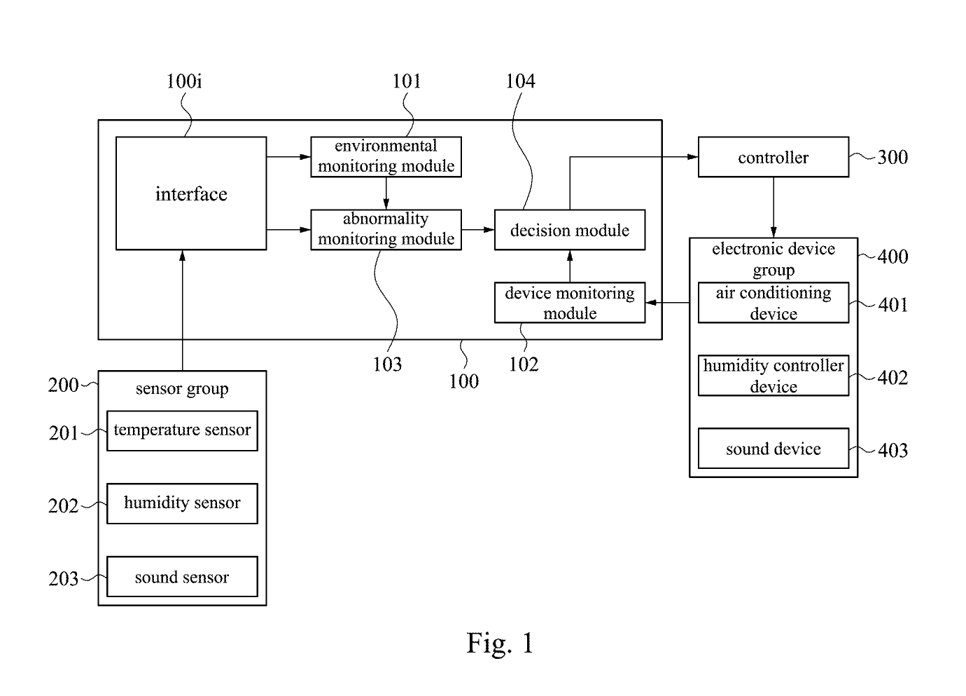

FIG. 1 is a schematic diagram of a device recommendation system in accordance with some embodiments of the present disclosure. As shown in FIG. 1, in this embodiment, the device recommendation system 100 at least includes an environmental monitoring module 101, a device monitoring module 102, an abnormality monitor module 103 and a decision module 104. The device recommendation system 100 is communicatively or electrically coupled to a sensor group 200 via an interface 100i, in which the interface 100i may be a wireless communication interface or a physical coupling interface. The device recommendation system 100 is further communicatively coupled to a controller 300 and an electronic device group 400, in which the sensor group 200 and the electronic device group 400 are arranged in a common space, and the space may be an enclosed space or a partly open space, for example, home or an office. In this embodiment, the device recommendation system 100 are mainly used to receive different environmental data collected from sensors in the sensor group 200 in the aforesaid space and to collect usage states of electronic devices in an electronic device group 400. The device recommendation system 100 further determines enablement status of each electronic devices in the electronic device group 400 according to a variation of the environmental data and enables or disables each electronic devices in the electronic device group 400 by controller 300. It is noted that the enable term here means to turn on and the disable term here means to turn off.

In this embodiment, the sensor group 200 at least includes a temperature sensor 201, a humidity sensor 202 and a sound sensor 203. The temperature sensor 201 may be a device used to detect the temperature in the space, for example, a resistance thermometer or an infrared thermometer. The temperature sensor 201 is used to sense a temperature variation in the space, to generate corresponding temperature data, and to transmit the temperature data to the environmental monitoring module 101 and the abnormality monitor module 103 in the device recommendation system 100. The humidity sensor 202 may be a device used to detect the amount of water vapor in the air in the space, for example, the resistance humidity meter or a thermal conductance humidity meter. Similarly, the humidity sensor 202 is used to sense a humidity variation in the space, to generate corresponding humidity data, and to transmit the humidity data to the environmental monitoring module 101 and the abnormality monitor module 103 in the device recommendation system 100. The sound sensor 203 may be a device used to detect the sound volume in the space, for example, a decibel meter. The sound sensor 203 is used to sense a volume variation in the space, to generate corresponding volume data, and to transmit the volume data to the environmental monitoring module 101 and the abnormality monitor module 103 in the device recommendation system 100. It is noted that the sensors included in the sensor group 200 are given for illustrative purposes, and the sensors in the sensor group 200 can be added or removed depending on the requirement of environmental data measurement.

In this embodiment, the electronic device group 400 at least includes an air conditioning device 401, a humidity controller device 402 and a sound device 403. The air conditioning device 401 may be a device used to change the temperature in the space, for example, an air conditioner. The humidity controller device 402 may be a device used to change the humidity of the air in the space, for example, a dehumidifier or a humidifier. The sound device 403 may be a device used to generate sound, for example, a speaker. The device monitoring module 102 in the device recommendation system 100 is used to monitor whether the air conditioning device 401, the humidity controller device 402 and the sound device 403 in the electronic device group 400 are in an on or off state. It is noted that the electronic devices included in the electronic device group 400 are given for illustrative purposes, and the electronic devices in the electronic device group 400 can be added or removed depending on the requirement of environmental data measurement.

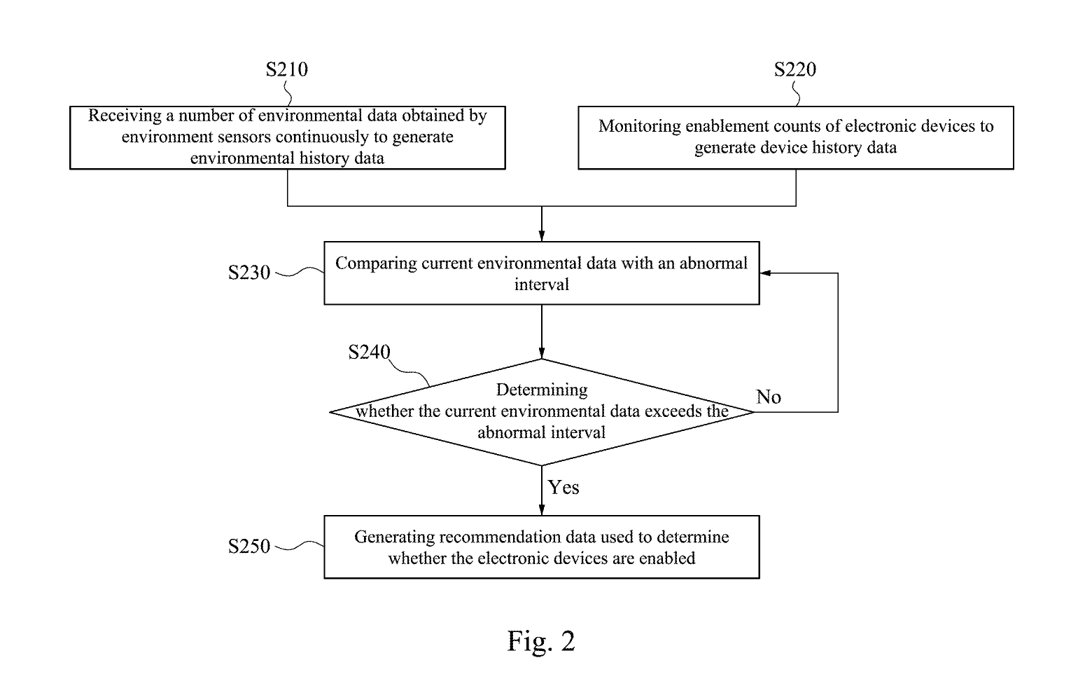

FIG. 2 is a schematic diagram of a device recommendation method in accordance with some embodiments of the present disclosure. In this embodiment, the device recommendation method is performed by the device recommendation system 100 in FIG. 1, in which the device recommendation system 100 is communicatively/electrically coupled to the sensor group 200, the controller 300 and the electronic device group 400, and the device recommendation system 100 includes the environmental monitoring module 101, the device monitoring module 102, the abnormality monitor module 103 and the decision module 104. The steps included in the device recommendation method are discussed in detail in the following paragraphs.

In operation S210, a number of environmental data obtained by a number of environmental sensors is continuously received to generate environmental history data. In one embodiment, this operation is performed by the environmental monitoring module 101 in the device recommendation system 100. During each cyclic time section of a long time interval, the environmental monitoring module 101 continuously receives temperature data obtained by the temperature sensor 201 in the space via the interface 100i, and the environmental monitoring module 101 calculates an average and a standard deviation of the temperature data in each cyclic time section of the long time interval to generate an environmental history data. In this embodiment, the length of the long time interval is a week, and the length of each cyclic time section is 15 minutes. For example, the cyclic time sections include time sections between 9:00 am to 9:15 am in each of seven days of the week. In other words, the environmental monitoring module 101 continuously receives the temperature data obtained in the space by the temperature sensor 201 during a week, calculates the average and the standard deviation of the temperature data in a certain 15 minutes time slot of a day during the week, and records the average and the standard deviation as part of the environmental history data related to the temperature data.

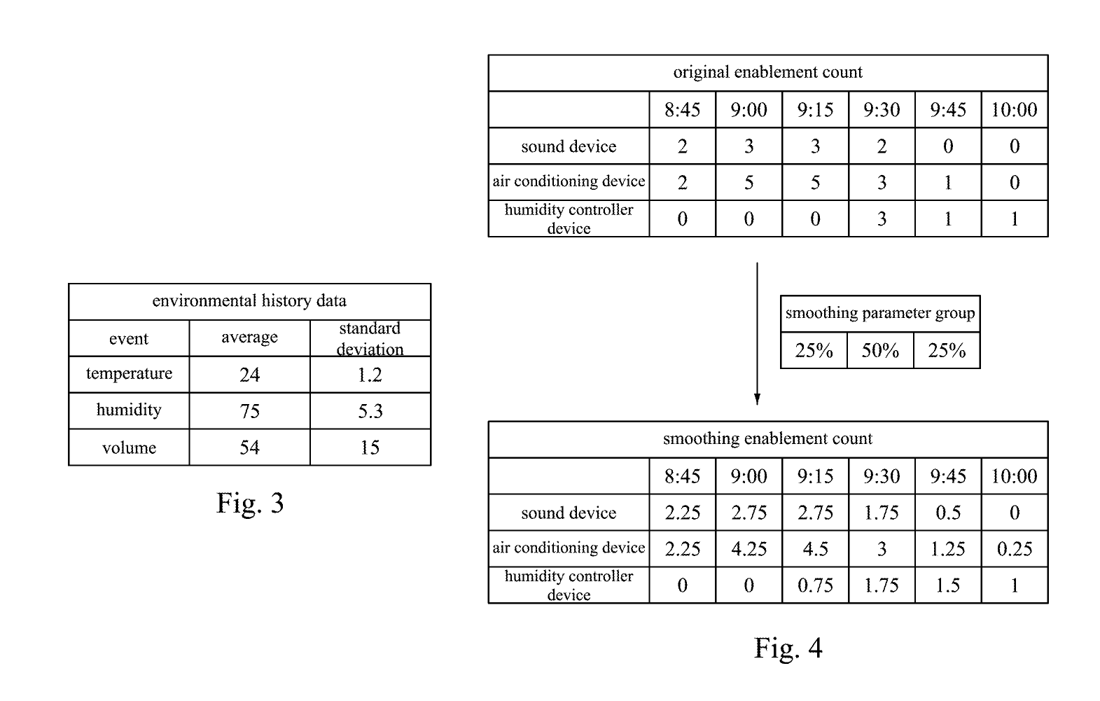

Similarly, the environmental monitoring module 101 continuously receives humidity data obtained by the humidity sensor 202 in the space via the interface 100i during a week, and calculates the average and the standard deviation of the humidity data in a certain 15 minutes time slot of a day during the week, and records the average and the standard deviation as part of the environmental history data related to the humidity data. The environmental monitoring module 101 continuously receives volume data obtained by the sound sensor 203 in the space via the interface 100i during a week, and calculates the average and the standard deviation of the volume data in a certain 15 minutes time slot of a day during the week, and records the average and the standard deviation as part of the environmental history data related to the volume data. In this embodiment, example related to the environmental history data references in FIG. 3. FIG. 3 is a schematic diagram of environmental history data in accordance with some embodiments of the present disclosure. The embodiment described in FIG. 3 is the average and the standard deviation of the environmental parameters in the cyclic time section from 9:00 am to 9:15 am. As shown in FIG. 3, the average temperature in the above cyclic time section in a week is 24 degree, and the standard deviation of temperature in the above cyclic time section in a week is 1.2. Similarly, the reading methods of the other environmental parameters can be obtained, and it will not be illustrated in details here.

In operation S220, enablement count of the electronic devices is monitored to generate device history data. In this embodiment, this operation is performed by the device monitoring module 102 in the device recommendation system 100. During each cyclic time section of a long time interval, the device monitoring module 102 continuously receives the enablement count of the air conditioning device 401, humidity controller device 402 and the sound device 403 in the electronic device group 400. The device monitoring module 102 then accumulates the enablement count of each electronic device in each cyclic time section in the long time interval and performs a smoothing process on the enablement count to generate device history data. Similarly, in this embodiment, the length of the long time interval is a week, and the length of each cyclic time section is 15 minutes. In other words, the device monitoring module 102 continuously accumulates the enablement count of each electronic device in the electronic device group 400 in each 15 minutes, and performs the smoothing process on the enablement count every 15 minutes according to the enablement count in the previous 15 minutes and the next 15 minutes, in which the example of smoothing process is illustrated in FIG. 4.

FIG. 4 is a schematic diagram of a smoothing process in accordance with some embodiments of the present disclosure. As shown in FIG. 4, the table on the top records the enablement count of each electronic device in 6 cyclic time sections. As shown, the enablement count of the sound device during the six 15-minute cyclic time section from 8:45 to 10:00 was (2, 3, 3, 3, 2, 0, 0) respectively. As can be seen from the table, the accumulated enablement count of the sound device activated from 8:45 am to 9:00 am per day during the week was 2, and the accumulated enablement count of the sound device activated from 9:00 am to 9:15 am per day during the week was 3. Similarly, the reading methods of other data in the table can be obtained, and it will not be illustrated in details here. As shown in FIG. 4, the table shown on the top records the smoothing enablement count of each electronic device processed by the smoothing process in 6 cyclic time sections. In this embodiment, the device monitoring module 102 performs calculation on an original enablement count by using smoothing parameter group in the table shown between the table on the top and the table on the bottom. As shown in FIG. 4, the smoothing parameter group includes three percentages of 25%, 50% and 25%, which represents the smoothing enablement count in the current cyclic time section is obtained by taking 25% of the original enablement count in the previous cyclic time section, 50% of the original enablement count in the current cyclic time section, and 25% of the original enablement count in the next cyclic time section. Take the starting time of 9:00 as an example, the smoothing enablement count of sound device 403 is calculated based on the following mathematical formula, (2*25%+3*50%+3*25%)=2.75. Similarly, the calculation methods of other smoothing enablement counts in the table can be obtained, and it will not be illustrated in details here.

After the above operation S210 and operation S220, the environmental monitoring module 101 in the device recommendation system 100 records the environmental history data in a week completely, and the device monitoring module 102 in the device recommendation system 100 records the device history data in a week completely. After a week, the device recommendation system 100 may perform the following operations. It is noted that, although the length of the long time interval in this embodiment is a week, and the length of each cyclic time section in this embodiment is 15 minutes, this is merely an example. In other embodiments, the device recommendation system 100 may record the environmental history data and the device history data with different lengths of time, and divides the environmental history data and the device history data by length of time to perform the above operations as well as the other operations below.

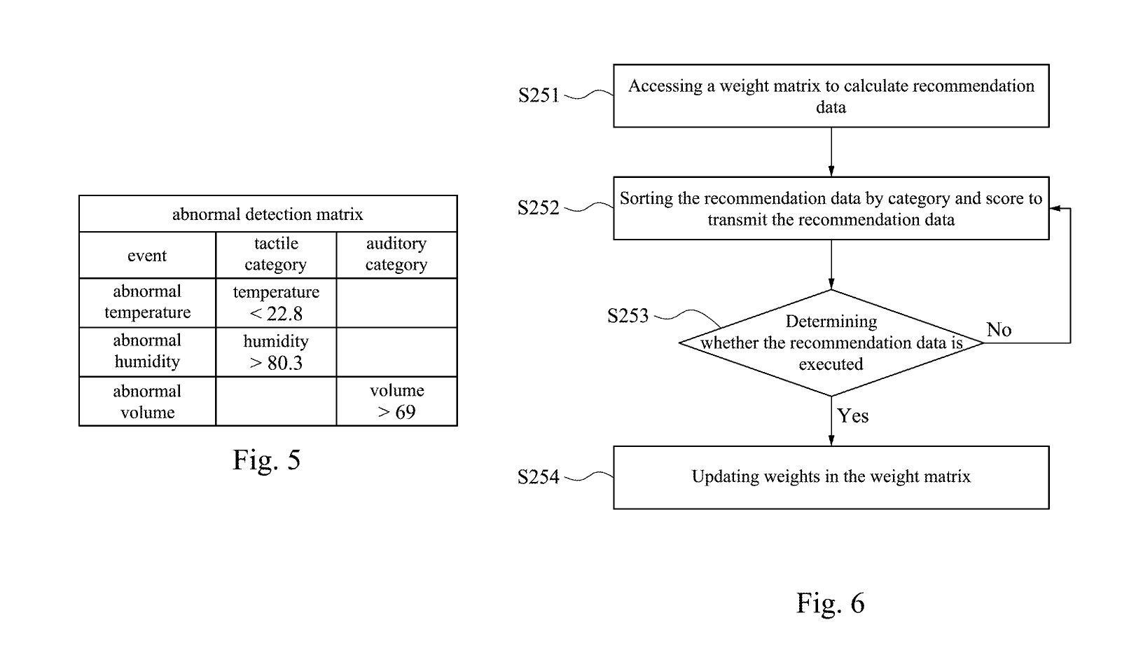

In operation S230, the current environmental data is compared with an abnormal interval. In this embodiment, this operation is performed by the abnormality monitor module 103 in the device recommendation system 100. It is noted that, in the device recommendation system 100 of present disclosure, not only the environmental monitoring module 101 continuously receives the environmental data obtained by the sensors in the sensor group 200 through the interface 100i, and the abnormality monitor module 103 also receives the environmental data through the interface 100i. In this embodiment, after a week of history data is collected, the abnormality monitor module 103 is used to compare the current environmental data with an abnormal interval in each cyclic time section of the second week. It is noted that in this embodiment, the abnormal interval is recorded in an abnormal detection matrix set according to the aforesaid environmental history data. An example of this abnormal detection matrix can be found in FIG. 5 of present disclosure.

FIG. 5 is a schematic diagram of an abnormal detection matrix in accordance with some embodiments of the present disclosure. The embodiment described in FIG. 5 is the abnormal detection matrix in the cyclic time section from 9:00 am to 9:15 am, in which the abnormal detection matrix is set according to the environmental history data in FIG. 3. As shown in FIG. 5, the abnormal detection matrix includes a category dimension and an abnormal dimension, in which the abnormal dimension includes abnormal temperature, abnormal humidity and abnormal volume, and the category dimension includes tactile category and auditory category. In the abnormal detection matrix, the abnormal temperature and the tactile category are corresponding to an abnormal temperature interval, in which the range of abnormal temperature interval is temperature less than 22.8 degrees. Reference is made to the environmental history data in FIG. 3, the abnormal temperature interval threshold, 22.8 is calculated from subtracting the standard deviation of the temperature (i.e., 1.2 degrees) form the average of the temperature (i.e., 24 degrees) in the cyclic time section from 9:00 am to 9:15 am. In addition, as shown in FIG. 5, the abnormal temperature interval is classified into a corresponding abnormal temperature category by the abnormality monitor module 103. Similarly, the calculation method and the classification method of the rest abnormal interval can be obtained, and it will not be illustrated in details here.

In operation S240, whether the current environmental data exceeds the abnormal interval is determined. After operation S230, the abnormality monitor module 103 is used to determine whether the current environmental data exceeds the abnormal interval in the abnormal detection matrix in each cyclic time section. If one of the current environmental data exceeds the corresponding abnormal interval, the abnormality monitor module 103 sends an abnormal signal, and operation S250 is performed. If the current environmental data does not exceed the corresponding abnormal interval, operation S230 is performed. In this embodiment, since the abnormality monitor module 103 determined the volume obtained by the sound sensor 203 is larger than 69 dB in the cyclic time section from 9:00 am to 9:15 am in the second week, the abnormality monitor module 103 sends the abnormal signal related to the abnormal volume data.

In operation S250, recommendation data used to determine whether the electronic devices are enabled is generated. In this embodiment, this operation is performed after the decision module 104 in the device recommendation system 100 received the abnormal signal sent by the abnormality monitor module 103. The decision module 104 performed this operation generates and transmits the recommendation data to the controller 300, in which the recommendation data includes information used to enable or disable several electronic device in the electronic device group 400. It is noted that operation S250 in FIG. 5 further includes detailed operations in FIG. 6. FIG. 6 is a schematic diagram of a device recommendation method in accordance with some embodiments of the present disclosure, and the detailed operations included in operation S250 are described in detail in the following paragraphs.

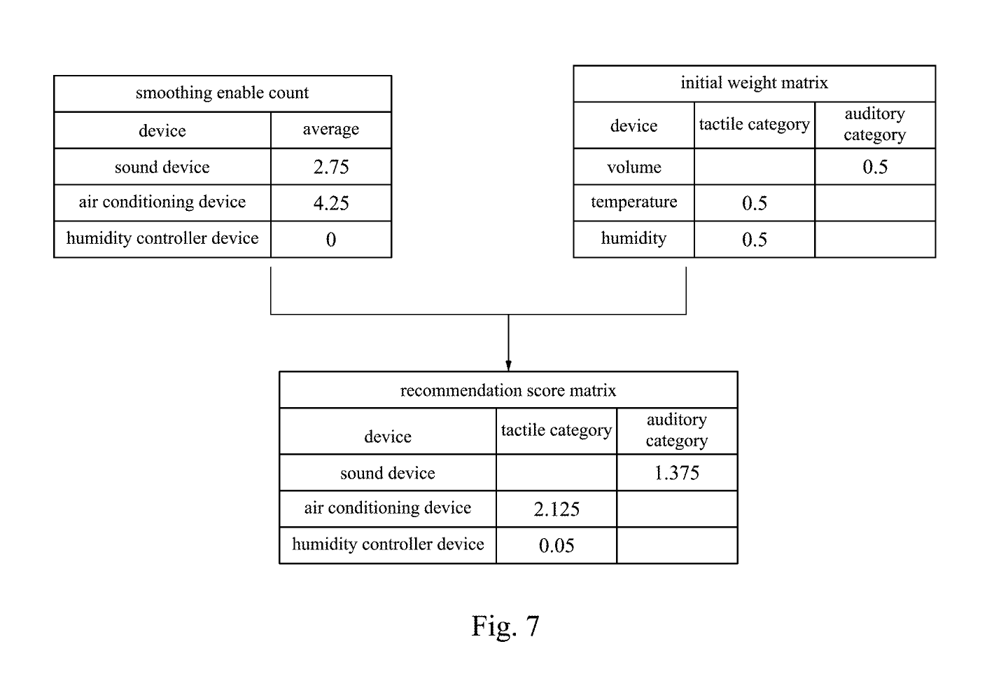

In operation S251, a weight matrix is accessed to calculate the recommendation data. In this embodiment, this operation is performed by the decision module 104 in the device recommendation system 100. When the decision module 104 receives the abnormal signal sent by the abnormality monitor module 103, the decision module 104 accesses an initial weight matrix. An example of the initial weight matrix can be found in FIG. 7. FIG. 7 is a schematic diagram of an initial weight matrix in accordance with some embodiments of the present disclosure. The table on the top right hand in FIG. 7 is the initial weight matrix. As shown in FIG. 7, the initial weight matrix includes a category dimension and an environment dimension, in which the category dimension includes the same tactile category and the auditory category as in the abnormal detection matrix, and the environment dimension includes a volume category, a humidity category and a temperature category corresponding to the environmental data obtained by the temperature sensor 201, the humidity sensor 202 and the sound sensor 203 respectively. The initial weight matrix includes three initial weights corresponding to an electronic device in the electronic device group 400. It is noted that since the initial weight matrix is for the first time accessed by the decision module 104, the initial weights in the initial weight matrix are all zeros, and the decision module 104 may initialize a predetermined initial value automatically to the initial weights, which are all zeros. Therefore, the three initial weights in the initial weight matrix each are equal to a predetermined value, 0.5.

In this embodiment, after the decision module 104 accesses the initial weight matrix, the decision module 104 utilizes the initial weight matrix to weight the aforesaid device history data, and generates the recommendation data used to determine whether the electronic devices in the electronic device group 400 is enabled accordingly. As shown in FIG. 7, the table on the top left hand is partial data shown in FIG. 4, in which the partial data is the smoothing enablement count monitored by the environmental monitoring module 101 from 9:00 am to 9:15 am last week. The smoothing enablement count of air conditioning device 401, the humidity controller device 402, and the sound device 403 in the cyclic time section are 4.25, 0 and 2.75 respectively. In this embodiment, the decision module 104 chooses the initial weights corresponding to the electronic devices via the category and environmental data in the initial weight matrix. For example, the initial weights corresponding to the air conditioning device 401 are belong to the tactile category and the temperature category respectively, and the initial weights corresponding to the humidity controller device 402 are belong to the tactile category and the humidity category respectively. In this embodiment, the decision module 104 performs weighting by multiplying each weight in the initial weight matrix by the smoothing enablement count of each electronic device and then generates the recommendation score matrix, as shown in the table on the bottom in FIG. 7. It is noted that if the recommendation score of the electronic device is still zero after weighting, the decision module 104 adjusts the recommendation score to 0.05.

In operation S252, the recommendation data is sorted by category and score to transmit recommendation data. In this embodiment, this operation is performed by the decision module 104 in the device recommendation system 100. After the decision module 104 calculates the recommendation score matrix, the decision module 104 determines the category of the abnormal signal according to the reason of the abnormal signal. Since the abnormal signal corresponds to the abnormal status of volume data, the decision module 104 may make a choice preferring to the electronic device in the auditory category in the recommendation score matrix, and sort the electronic device in the auditory category according to the recommendation scores. As shown in FIG. 7, since the auditory category only includes the sound device 403, the sound device 403 is selected to be the recommendation data in level 1 by the decision module 104. Next, the decision module 104 selects the electronic device with its recommendation score higher than a predetermined threshold (e.g., 0.05) in other categories in the recommendation score matrix as the recommendation data in level 2, and the electronic device with its recommendation score lower than the predetermined threshold in other categories in the recommendation score matrix as the recommendation data in level 3. As shown in FIG. 7, in this embodiment, the air conditioning device 401 with its recommendation score 2.125 is selected to be the recommendation data in level 2 by the decision module 104, and the humidity controller device 402 is selected to be the recommendation data in level 3 by the decision module 104. After the recommendation data is determined, the decision module 104 transmits the recommendation data in order from level 1 to level 3 to the controller 300, and the following operation is performed depending on the selection result of the controller 300. Besides, since the reason of the abnormal signal is that the volume is too high, the recommendation data is used to disable the aforesaid electronic device.

In operation S253, it is determined whether the recommendation data is executed. In this embodiment, this operation is performed by the decision module 104 in the device recommendation system 100. After the decision module 104 transmits the recommendation data to the controller 300, the controller 300 graphically displays the recommendation data on a display screen (not shown) of the controller 300, and the device monitoring module 102 in the device recommendation system 100 continuously monitors the enablement status of each electronic device in the electronic device group 400. If the recommendation data is executed, the decision module 104 can determine the recommendation data being executed according to the enablement status of each electronic device obtained from the device monitoring module 102. On the other hand, if the recommendation data is not executed, the decision module 104 transmits the recommendation data in another level to the controller 300. In this embodiment, the controller 300 is an automatic, semi-automatic or manual programmable logic controller (PLC), and the controller 300 may select the electronic device in the recommendation data automatically or by users to transmit a control signal used to enable or disable the electronic device to the selected electronic device. In this embodiment, the controller 300 selects the recommendation data in level 2 instead of in level 1, such that the controller 300 transmits the control signal to disable the air conditioning device 401, and the air conditioning device 401 may be turned off.

In operation S254, the weights in weight matrix are updated. In this embodiment, this operation is performed by the decision module 104 in the device recommendation system 100. Since some of the environmental data changes may be more easily detected after an interval of time, if the decision module 104 of present disclosure still receives the abnormal signal from the abnormality monitor module 103 from 9:15 am to 9:30 am in the second week, the decision module 104 may not adjust each initial weight in the initial weight matrix before the abnormal signal disappears. In this embodiment, if the abnormality monitor module 103 does not transmit the abnormal signal from 9:15 am to 9:30 am in the second week, the decision module 104 may determine how to adjust each initial weight in the initial weight matrix according to the environmental data obtained from the environmental monitoring module 101. Since the controller 300 disables the electronic devices in the electronic device group 400 according to the recommendation data in level 2 instead of the recommendation data in level 1, the decision module 104 subtracts the initial weights in the auditory category in the weight matrix by 0.1.

However, turning off the air conditioning device 401 not only affects the volume data, but also affects the temperature data and the humidity data. Therefore, although the volume data obtained by the environmental monitoring module 101 is reduced, the temperature data and the humidity data may have a significantly change. Such that the decision module 104 adds 0.1 to each initial weight in the auditory category corresponding to the humidity category and the temperature category in the weight matrix. Accordingly, the decision module 104 may adjust the initial weights in the initial weight matrix to generate an adjusted weight matrix.

In this embodiment, in the following cyclic time sections, when the decision module 104 receives the abnormal signal from the abnormality monitor module 103, the decision module 104 may access and weight the adjusted weight matrix to update the device history data continuously. When the abnormal signal disappears, the decision module 104 updates the adjusted weight matrix according to the above operation.

It is noted that, in this embodiment, the device recommendation system 100 includes a processor (not shown) and a storage device (not shown). The processor may be a central processing unit (CPU) in the computer device. The processor can be programmed to interpret computer instructions, process data in computer software, and execute various computing programs. The storage device may include a main memory and an auxiliary memory. The storage device and the processor in the device recommendation system 100 may be used to load the instructions in the storage device and execute the instructions. The environmental monitoring module 101, the device monitoring module 102, the abnormality monitor module 103 and the decision module 104 included in the device recommendation system 100 are part of the processor. When the processor in the device recommendation system 100 executes the aforesaid instructions, the modules in the device recommendation system 100 may be driven to execute the aforesaid functions respectively. About the functions of the modules, reference may be made to the foregoing embodiments, and details are not described herein again.

Since the prior art does not consider that many kinds of electronic devices may affect a number of the environmental data simultaneously, its control efficiency is unsatisfactory. As can be seen from the above embodiments, the device recommendation system 100 and the device recommendation method of present disclosure can consider the complex influence of a number of electronic devices on a number of environmental data at the same time and continuously perform machine learning based on feedback. The device recommendation method of present disclosure has better control efficiency than the prior art, and can reduce energy consumption of the devices and intelligently improve the comfort of the environment.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device recommendation system, comprising:
an interface receiving a plurality of environmental data in a plurality of cyclic time sections obtained by a plurality of environmental sensors; and
a processor electrically coupled to the interface and communicatively coupled to a plurality of electronic devices, wherein the processor comprises:
an environmental monitoring module generating environmental history data according to the plurality of environmental data in the cyclic time sections obtained by the environmental sensors;
a device monitoring module generating device history data according to a plurality of enablement counts of a plurality of electronic devices in the cyclic time sections;
an abnormality monitor module determining whether the plurality of environmental data exceeds an abnormal interval in the environmental history data in a first time section in the cyclic time sections, and generating an abnormal signal when one of the plurality of environmental data exceeds the abnormal interval; and
a decision module calculating the environmental history data via an initial weight matrix to generate first recommendation data when the decision module receives the abnormal signal, wherein the first recommendation data is configured to determine whether to enable the electronic devices, wherein the initial weight matrix comprises a plurality of initial weights corresponding to the electronic devices, wherein if the decision module does not receive the abnormal signal in a second time section in the cyclic time section, the decision module adjusts the initial weights in the initial weight matrix according to a variation of the plurality of environmental data and the first recommendation data to generate an adjusted weight matrix, wherein the decision module calculates the device history data according to the adjusted weight matrix to generate second recommendation data when the decision module receives the abnormal signal in a third time section in the cyclic time section, wherein the second recommendation data is configured to determine whether to enable the electronic devices.

2. The device recommendation system of claim 1, wherein the device monitoring module multiplies the enablement counts in each of the cyclic time sections and the enablement counts in previous and next of the each of the cyclic time sections by a percentage respectively to smooth the enablement counts in the cyclic time sections.

3. The device recommendation system of claim 1, wherein the decision module transmits the first recommendation data and the second recommendation data to a display screen, and the display screen graphically displays the first recommendation data and the second recommendation data.

4. The device recommendation system of claim 1, wherein the decision module transmits the first recommendation data and the second recommendation data to the electronic devices to enable the electronic devices.

5. The device recommendation system of claim 1, wherein the plurality of environmental data each corresponds to one of a plurality of categories, and the weights in the initial weight matrix and the adjusted weight matrix are each corresponding to one of the categories.

6. The device recommendation system of claim 5, wherein the decision module calculates the device history data via the initial weight matrix to generate a result corresponding to the electronic devices respectively, the decision module corresponds the plurality of environmental data determined to exceed the abnormal interval to a first category of the categories, and the decision module selects the electronic devices according to the first category to generate the first recommendation data.

7. The device recommendation system of claim 6, wherein the electronic devices being enabled in the first recommendation data is corresponding to one of the weights in the initial weight matrix, and the one of the weights is corresponding to the first category.

8. The device recommendation system of claim 1, wherein if the decision module still receives the abnormal signal in the second time section in the cyclic time sections, the decision module does not adjust the initial weight matrix before the abnormal signal disappears.

9. A device recommendation method performed by a processor, wherein the processor is electrically coupled to a plurality of environmental sensors via an interface and is communicatively coupled to a plurality of electronic devices, and the processor comprises an environmental monitoring module, a device monitoring module, an abnormality monitor module and a decision module, wherein the device recommendation method comprises:
the environmental monitoring module generating environmental history data according to a plurality of environmental data in a plurality of cyclic time sections obtained by the environmental sensors;
the device monitoring module generating device history data according to a plurality of enablement counts in the cyclic time sections of a plurality of electronic devices;
the abnormality monitor module determining whether the plurality of environmental data exceeds an abnormal interval in the environmental history data in a first time section in the cyclic time sections, and generating an abnormal signal when one of the plurality of environmental data exceeds the abnormal interval;
the decision module calculating the environmental history data via an initial weight matrix to generate first recommendation data when the decision module receives the abnormal signal, wherein the first recommendation data is configured to determine whether to enable the electronic devices, wherein the initial weight matrix comprises a plurality of initial weights corresponding to the electronic devices;
if the decision module does not receive the abnormal signal in a second time section in the cyclic time sections, the decision module adjusting the initial weights in the initial weight matrix according to a variation of the plurality of environmental data and the first recommendation data to generate an adjusted weight matrix; and
the decision module calculating the device history data to generate second recommendation data according to the adjusted weight matrix when the decision module receives the abnormal signal in a third time section in the cyclic time sections, wherein the second recommendation data is configured to determine whether to enable the electronic devices.

10. The device recommendation method of claim 9, further comprising:
the device monitoring module multiplying the enablement counts in each cyclic time sections and the enablement counts in previous and next of the each of the cyclic time sections by a percentage respectively to smooth the enablement counts in the cyclic time sections.

11. The device recommendation method of claim 9, further comprising:
the decision module transmitting the first recommendation data and the second recommendation data to a display screen, and the display screen graphically displays the first recommendation data and the second recommendation data.

12. The device recommendation method of claim 9, further comprising:
the decision module transmitting the first recommendation data and the second recommendation data to the electronic devices to enable the electronic devices.

13. The device recommendation method of claim 9, wherein the plurality of environmental data each corresponds to one of a plurality of categories, and the weights in the initial weight matrix and the adjusted weight matrix are each corresponding to one of the categories.

14. The device recommendation method of claim 13, further comprising:
the decision module calculating the device history data via the initial weight matrix to generate a result corresponding to the electronic devices respectively;
the decision module corresponding the environmental data determined to exceed the abnormal interval to a first category of the categories; and
the decision module selecting the electronic devices to generate the first recommendation data according to the first category.

15. The device recommendation method of claim 14, wherein the electronic devices being enabled in the first recommendation data is corresponding to one of the weights in the initial weight matrix, and the one of the weights is corresponding to the first category.

16. The device recommendation method of claim 9, further comprising:
if the decision module still receives the abnormal signal in the second time section in the cyclic time sections, keeping the initial weight matrix not adjusted by the decision module before the abnormal signal disappears.
